(19) United States
(12) Patent Application Publication
(10) Pub. No.: US 2014/0366955 A1
(43) Pub. Date: Dec. 18, 2014

(54) REMOTE REGULATOR FOR ROOF BOLTER

(71) Applicant: Caterpillar Global Mining America LLC, Houston, PA (US)

(72) Inventor: Jeffrey D. Looney, Christiansburg, VA (US)

(21) Appl. No.: 13/916,862

(22) Filed: Jun. 13, 2013

(51) Int. Cl. B23Q 5/06; E21B 44/04

(52) U.S. Cl. CPC B23Q 5/06; E21B 44/04; B23Q 2005/005
USPC 137/102

(57) ABSTRACT

A regulator for controlling operation of a drill thrust actuator and a drill rotation actuator in a roof bolter, is provided. The regulator includes a first pressure relief unit, a second pressure relief unit and a flow control valve. The first pressure relief unit is configured to selectively allow a hydraulic fluid to pass to the drill thrust actuator. The second pressure relief unit is configured to selectively allow the hydraulic fluid to pass to the drill rotation actuator. Further, the flow control valve is configured to selectively adjust a flow of the hydraulic fluid to the drill rotation actuator.

### TECHNICAL FIELD

The present disclosure relates to a roof bolter, and particularly to a remote regulator for regulating drill speed, thrust pressure, and rotation pressure during a roof bolting operation.

### BACKGROUND

Roof bolter machines are generally used in mining industry for securing mine roofs to be self supportive. Generally, there may be two types of operations that the roof bolters perform, namely, drilling operations and bolting operations. The drilling operations include drilling the roof and the bolting operations include inserting bolts such as cable bolts, or resin roof bolts, etc., and subsequently tightening the inserted bolts.

An operator of the roof bolter may need to change drill speed, rotation pressure and thrust pressure based on a number of factors. These factors may include the type of operation being performed, material being drilled, hardness of the material, and size of the drill etc. Conventionally, separate multiple hydraulic valves are used to change the drill speed, rotation pressure and thrust pressure of the roof bolter. This is very inconvenient and cumbersome.

U.S. Pat. No. 5,564,455 relates to a hydraulic circuit for use in controlling a horizontal boring machine which requires hydraulic fluid under pressure for rotating a drill bit or back reamer through a rotation circuit and hydraulic fluid under pressure for thrusting the drill bit or back reamer within the bore hole through a thrust circuit. Pressures from both the thrust circuit and control circuit are combined through restrictors in a mixing zone or area. The control port of a diversion valve is connected to mixing zone. When the combined pressure in the mixing zone exceeds the adjustable spring bias on the diversion valve, the diversion valve will open, diverting fluid from the thrust circuit to a low pressure zone. This will cause a reduction in the pressure in the rotation circuit as well. The reduction of both pressures will reduce the combined pressure in the mixing zone, causing the diversion valve to close and the pressures to increase. The hydraulic circuit maintains a constant maximum output for both circuits for a given horsepower input to the boring machine and productivity is enhanced due to reduced operator fatigue.

### SUMMARY

In one aspect, a regulator for controlling operation of a drill thrust actuator and a drill rotation actuator in a roof bolter, is provided. The regulator includes a first pressure relief unit, a second pressure relief unit and a flow control valve. The first pressure relief unit is configured to selectively allow a hydraulic fluid to pass to the drill thrust actuator. The second pressure relief unit is configured to selectively allow the hydraulic fluid to pass to the drill rotation actuator. Further, the flow control valve is configured to selectively adjust a flow of the hydraulic fluid to the drill rotation actuator.

In another aspect, a roof bolter is provided. The roof bolter includes a drill assembly, a main control valve and a regulator hydraulically coupled to the main control valve. The drill assembly has a drill thrust actuator and a drill rotation actuator. Further, the main control valve is configured to supply a hydraulic fluid to the drill thrust actuator and the drill rotation actuator. Furthermore, the regulator includes a first pressure relief unit, a second pressure relief unit and a flow control valve. The first pressure relief unit is configured to selectively allow a hydraulic fluid to pass to the drill thrust actuator. The second pressure relief unit is configured to selectively allow the hydraulic fluid to pass to the drill rotation actuator. Further, the flow control valve is configured to selectively adjust a flow of the hydraulic fluid to the drill rotation actuator.

In a yet another aspect, a regulator for controlling operation of a drill thrust actuator and a drill rotation actuator in a roof bolter, is provided. The regulator includes a first pressure relief cartridge valve configured to provide a first pressure relief for the drill thrust actuator. The regulator further includes a second pressure relief cartridge valve configured to provide a second pressure relief for the drill thrust actuator. The regulator includes a third pressure relief cartridge valve configured to provide a first pressure relief for the drill rotation actuator. Additionally, the regulator includes a fourth pressure relief cartridge valve configured to provide a second pressure relief for the drill rotation actuator. Furthermore, the regulator includes a flow control valve configured to selectively adjust a flow of the hydraulic fluid to the drill rotation actuator.

### BRIEF DESCRIPTION OF THE DRAWINGS

FIG. 1 illustrates a perspective view of a roof bolter, according to the embodiments of the present disclosure;

FIG. 2 illustrates a schematic view of a hydraulic system associated with a drill assembly of the roof bolter of FIG. 1, according to an embodiment of the present disclosure;

FIG. 3 illustrates a perspective view of a remote regulator, in accordance with an embodiment of the present disclosure; and

FIG. 4 illustrates a schematic view of the remote regulator of FIG. 3, according to an embodiment of the present disclosure.

### DETAILED DESCRIPTION

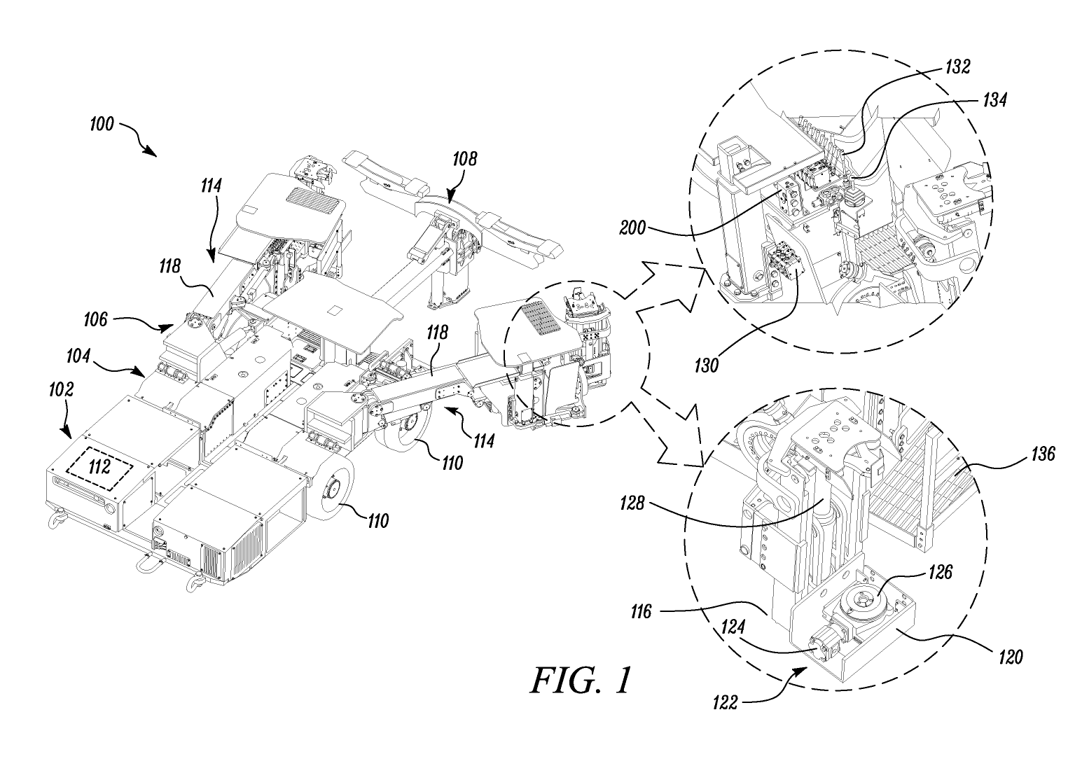

The present disclosure relates to a remote regulator for regulating drill speed, thrust pressure, and rotation pressure during a roof bolting operation. FIG. 1 illustrates a machine 100 used for drilling holes and inserting bolts in mine roofs. According to an aspect of the present disclosure, the machine 100 is embodied as a mobile roof bolter. The machine 100 includes a rear frame portion 102, a center frame portion 104 disposed in front of the rear frame portion 102, and a front frame portion 106 disposed in front of the center frame portion 104 and pivotally connected thereto. In an aspect of the present disclosure, the front frame portion 106 may be provided with a temporary roof support 108. Further, ground engaging members 110 such as wheels or tracks may be provided on the machine 100. A drivetrain (not shown) may operatively couple a power source 112 to the ground engaging members 110. The power source 112 may be enclosed within the rear frame portion 102. The drivetrain may include any one or a combination of, but not limited to, gearing, differentials, drive shafts and hydraulic and/or pneumatic circuits including valves, lines, distribution manifolds and the like. The drivetrain may be configured to transmit power from the power source 112 to the ground engaging members 110.

The machine 100 may include drill boom assemblies 114 pivotally coupled on opposite sides of the front frame portion 106. Each of the drill boom assembly 114 includes a drill mast 116 forwardly mounted on a boom 118. The boom 118 may be pivotally mounted on the front frame portion 106 and is configured to move within a pre-determined angular range by a hydraulic mechanism. A baseplate 120 is mounted to a bottom section of the drill mast 116. The baseplate 120 supports a drill assembly 122 including a drill rotation actuator 124 and a chuck 126 which is coupled to the drill rotation actuator 124. The chuck 126 is configured to receive a drill bit or a bolt. Further, the drill assembly 122 includes a drill thrust actuator 128 to guide the drill assembly 122 along the drill mast 116.

A main control valve 130 is provided on the drill boom assembly 114 and configured to supply a hydraulic fluid to the drill rotation actuator 124 and the drill thrust actuator 128. In an aspect of the present disclosure, the main control valve 130 may be configured to preset an upper thrust pressure value and an upper rotation pressure value associated with the drill thrust actuator 128 and the drill rotation actuator 124. Further, the drill boom assembly 114 may include a fast feed diversion actuator 132 configured to control a flow rate of pressurized hydraulic fluid to the drill thrust actuator 128. Furthermore, the drill boom assembly 114 may include a feed/rotation control actuator 134 configured to control a supply pressure to the drill rotation actuator 124 and the drill thrust actuator 128. The drill boom assembly 114 may also include a fast feed control actuator (not shown) configured to provide a movement of the drill assembly 122 when the drill bit or a bolt is desired to move fast to reach upto a roof for drilling and bolting operations. In an exemplary embodiment of the present disclosure, the fast feed diversion actuator 132, the feed/rotation control actuator 134 and the fast feed control actuator may be positioned within the drill boom assembly 114 such that they are easily accessible by an operator standing on an operator platform 136. The fast feed diversion actuator 132, the feed/rotation control actuator 134 and the fast feed control actuator may be implemented using control stick and lever.

In an aspect of the present disclosure, a remote regulator 138 (hereinafter referred to as regulator 138) may be provided in the drill boom assembly 114 and configured to control the operation of the drill thrust actuator 128 and the drill rotation actuator 124. In an exemplary embodiment, the regulator 138 may be configured to regulate a drill speed, a thrust pressure and a rotation pressure by controlling the flow rate of the pressurized hydraulic fluid and the supply pressure to the drill rotation actuator 124 and the drill thrust actuator 128, respectively. The regulator 138 may facilitate the operator to control the operation of the drill rotation actuator 124 and the drill thrust actuator 128 based on a bolting operation, or drilling operation.

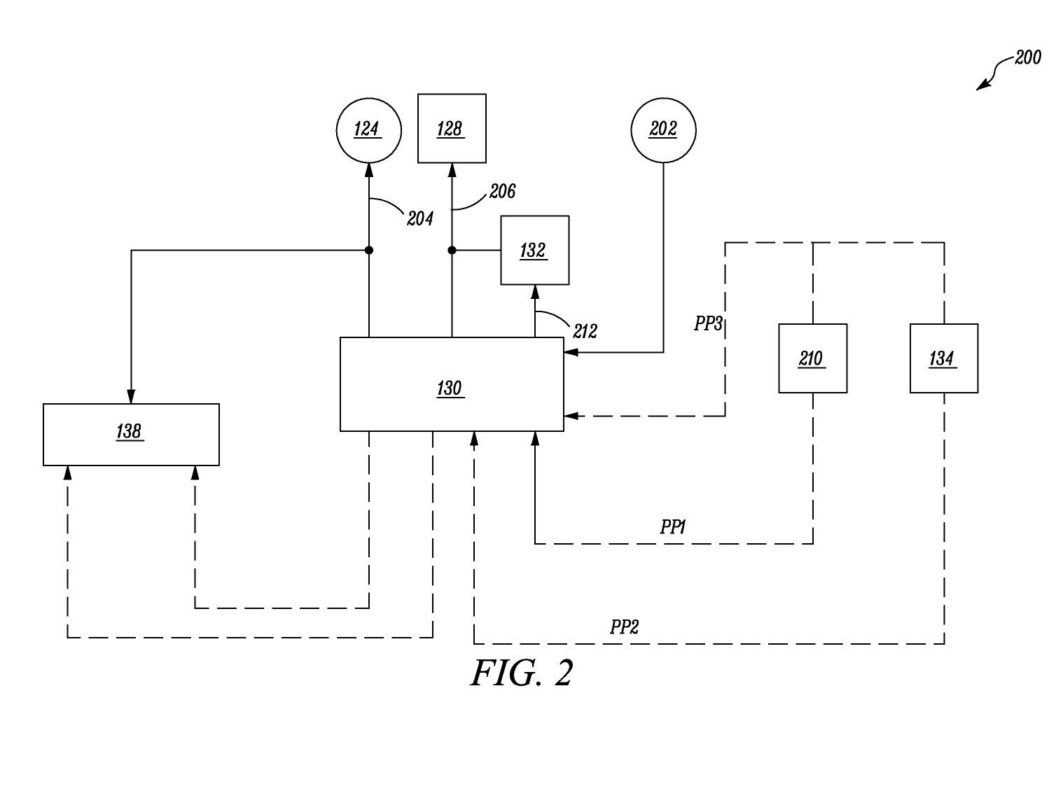

FIG. 2 illustrates a schematic view of a hydraulic system 200 associated with the drill assembly 122 of the machine 100. As illustrated, the main control valve 130 is configured to supply a hydraulic fluid to the drill rotation actuator 124 and the drill thrust actuator 128 from a hydraulic pump 202 via a first conduit 204 and a second conduit 206, respectively. The hydraulic pump 202 which may be driven by the power source 112, and is hydraulically coupled to the main control valve 130 via a third conduit 208. The main control valve 130 may selectively supply the pressurized hydraulic fluid to the drill rotation actuator 124 and the drill thrust actuator 128 based on an operator input received via a fast feed control actuator 210 and the feed/rotation control actuator 134. As illustrated, the fast feed control actuator 210 and the feed/rotation control actuator 134 are configured to supply a first, a second pilot pressure PP1, PP2, and a third pilot pressure PP3 to the main control valve 130 to preset the upper thrust pressure value and the upper rotation pressure value respectively.

Moreover, the fast feed diversion actuator 132 is provided to control the flow rate of the pressurized hydraulic fluid to the drill thrust actuator 128 and control the movement of the drill assembly 122. The fast feed diversion actuator 132 is hydraulically coupled to the second conduit 206 to selectively increase the flow rate to the drill thrust actuator 128 by supplying the fluid flow via a fourth conduit 212.

In an aspect of the present disclosure, the regulator 138 is hydraulically coupled to the main control valve 130 to control the flow rate of the pressurized hydraulic fluid and the supply pressure to the drill thrust actuator 128 and the drill rotation actuator 124. As shown in FIG. 2, the main control valve 130 is configured to supply a thrust pilot pressure TP and a rotation pilot pressure RP to the regulator 138. The regulator 138 is configured to selectively relieve the thrust pilot pressure TP and the rotation pilot pressure RP based on the drilling or the bolting operation of the machine 100. Furthermore, the regulator 138 may be configured to selectively increase and/or decrease the flow rate to the drill rotation actuator 124 by diverting the fluid flow into a tank (not shown).

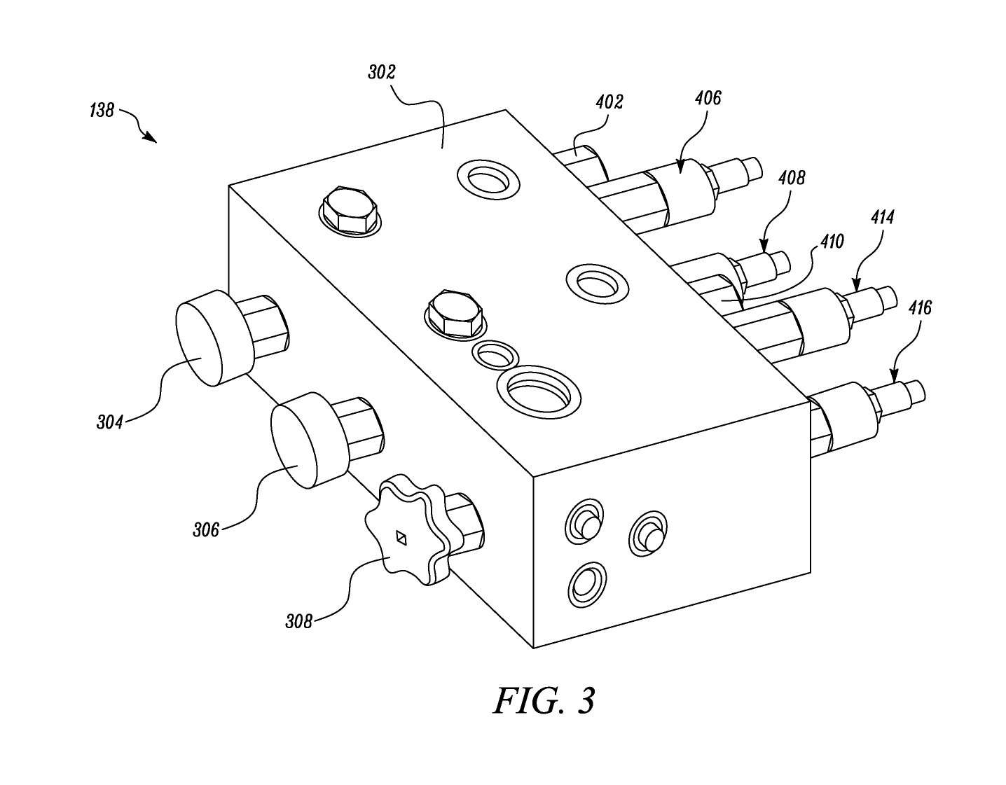

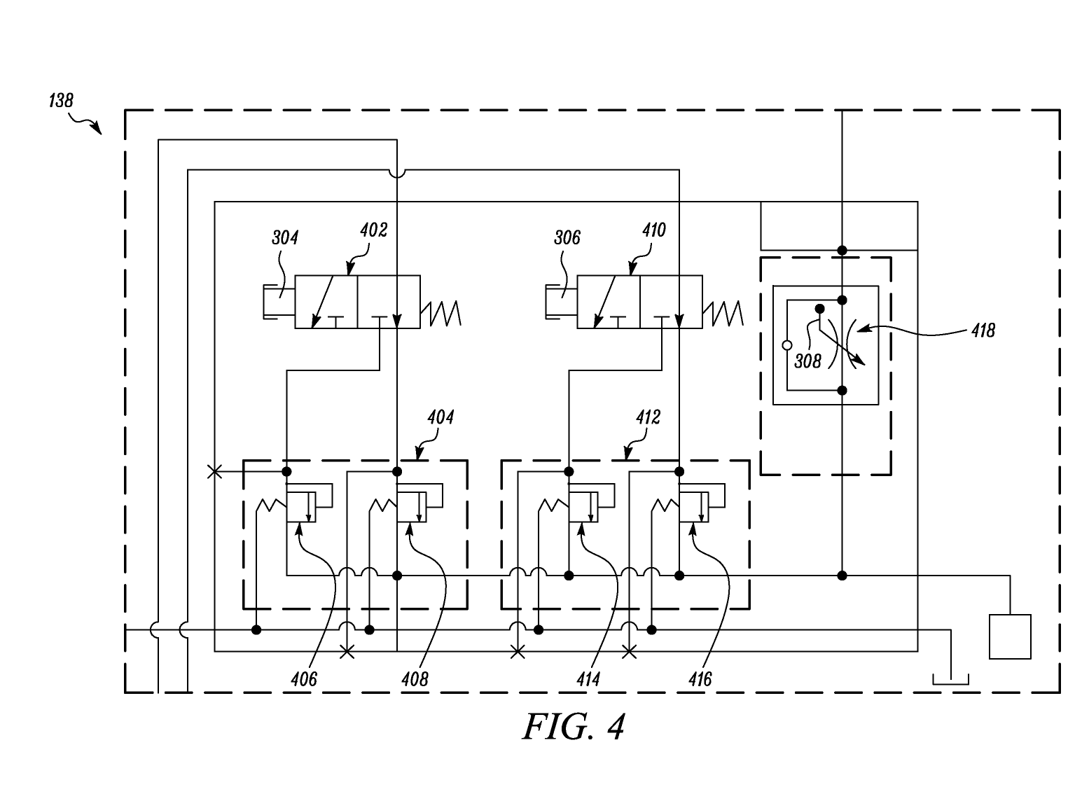

FIG. 3 illustrates a perspective view of the regulator 138. FIG. 4 illustrates a schematic view of the regulator 138, which is further explained in conjunction with FIG. 3. In an aspect of the present disclosure, the regulator 138 may be enclosed within a housing 302. For example, the housing 302 may be a metallic housing, a wooden housing, a plastic housing or the like. The regulator 138 may include a first input device 304, a second input device 306, and a third input device 308, provided on the housing 302. The first input device 304 may be configured to control the thrust pressure at the drill thrust actuator 128 which may be required for at least one of the drilling operations, and the bolting operations. Further, the second input device 306 may be configured to control the rotation pressure at the drill rotation actuator 124, required for drilling operations and bolting operations. Furthermore, the third input device 308 may be configured to regulate rotational speed at the drill rotation actuator 124 for drilling and/or the bolting operations. In an exemplary embodiment, the first and the second input devices 304, 306 may be push buttons, and the third input device 308 may be a star shaped rotary knob configured to provide speed regulation for the drill speed.

As shown in FIG. 4, the first input device 304 may be associated with a first three-way valve 402 which is further connected to a first pressure relief unit 404 configured to selectively allow a hydraulic fluid to pass to the drill thrust actuator 128 based on the type of operation, material being drilled, and size of the drill. In an aspect of the present disclosure, the first pressure relief unit 404 may include a first pressure relief cartridge 406 and a second pressure relief cartridge 408. In an aspect of the present disclosure, the first three-way valve 402 may be configured to selectively actuate at least one of the first pressure relief cartridge 406 and the second pressure relief cartridge 408. In an exemplary embodiment, the first pressure relief cartridge 406 may be configured to provide a first pressure relief for the drill thrust actuator 128 by limiting the thrust pilot pressure TP corresponding to the thrust pressure required for drilling operations of the machine 100. Further, the second pressure relief cartridge 408 may be configured to provide a second pressure relief for the drill thrust actuator 128 by limiting the thrust pilot pressure TP corresponding to a rib drill thrust which may be indicative of the thrust pressure for bolting operations of the machine 100.

For example, the first three-way valve 402 may be set at a first position by using the first input device 304 to actuate the first pressure relief cartridge 406 which provides the thrust settings for drilling operations to the drill thrust actuator 128. Therefore, if the drill assembly 122 performs drilling operation, corresponding thrust required for the drill thrust actuator 128 may be provided by actuating the first pressure relief cartridge 406. Similarly, the first three-way valve 402 may be set at a second position by using the first input device 304 to actuate the second pressure relief cartridge 408 to provide rib drill thrust settings for bolting operations to the drill thrust actuator 128. If the drill assembly 122 performs bolting operation, then the corresponding thrust required for the drill thrust actuator 128 is different from the thrust required for drilling operations, which is provided by actuating the second pressure relief cartridge 408.

In an aspect of the present disclosure, the second input device 306 may be associated with a second three-way valve 410. The second three-way valve 410 may be further connected to a second pressure relief unit 412 having a third pressure relief cartridge 414 and a fourth pressure relief cartridge 416. The second three-way valve 410 is configured to selectively actuate at least one of the third pressure relief cartridge 414 and the fourth pressure relief cartridge 416. The second pressure relief unit 412 may be configured to selectively allow the hydraulic fluid to pass to the drill rotation actuator 124 based on the selective actuation of the third pressure relief cartridge 414 or the fourth pressure relief cartridge 416.

The third pressure relief cartridge 414 may be configured to provide a first pressure relief for the drill rotation actuator 124 by limiting the rotation pilot pressure RP corresponding to a drilling torque required for drilling operations of the machine 100. Further, the fourth pressure relief cartridge 416 may be configured to provide a second pressure relief for the drill rotation actuator 124 by limiting the rotation pilot pressure RP corresponding to a bolting torque required for bolting operations of the machine 100.

In an aspect of the present disclosure, the regulator 138 may further include a flow control valve 418 associated with the third input device 308. The flow control valve 418 is configured to selectively adjust a flow of the hydraulic fluid to the drill rotation actuator 124. In an exemplary embodiment, the flow control valve 418 is configured to be adjusted corresponding to the required adjustment in the drill rotational speed based on whether the drill assembly 122 is performing a drilling function or a bolting function. Furthermore, the flow of the hydraulic fluid to the drill rotation actuator 124 may be adjusted to regulate the rotational speed of the drill bit for the drilling operations and for the bolting operations.

In an aspect of the present disclosure, based on the settings set by using the regulator 138, pressure signals from the main control valve 130 to the drill thrust actuator 128 and the drill rotation actuator 124 may be regulated and/or controlled. As explained previously, the pressure to the drill thrust actuator 128 and the drill rotation actuator 124 may be controlled based on the desired function such as the drilling operation and/or the bolting operation performed by the drill assembly 122.

### INDUSTRIAL APPLICABILITY

The industrial applicability of the remote regulator 138 for the roof bolter 100 described herein will be readily appreciated from the foregoing discussion.

Roof bolter machines are generally used in mining industry for securing mine roofs to be self supportive. Generally, there may be two types of operations that the roof bolters perform, namely, drilling operations and bolting operations. The drilling operations include drilling the roof directly and bolting operations include inserting conventional bolts, cable bolts, or resin roof bolts and subsequently tightening of the inserted bolts.

An operator of the roof bolter may need to change drill speed, rotation pressure and thrust pressure based on a number of factors. The factors may include type of operation being performed, material being drilled, hardness of the material etc. For example, for drilling type operation, the drilling thrust required may be greater than that required for bolting operations. Similarly, for a hard material being drilled, the required drill speed, rotation pressure and thrust pressure may be higher than that for a soft material. Conventionally, separate multiple hydraulic valves are used to control the drill speed, rotation pressure and thrust pressure of the roof bolter. This is very inconvenient and cumbersome.

The remote regulator 138 of the present disclosure, eliminates the separate multiple hydraulic valves for regulating the drill speed, thrust pressure and rotation pressure for the various operations of the roof bolter machine 100. In an aspect of the present disclosure, the remote regulator 138 is provided on each side of the drill boom assembly 114 to facilitate the operator on either sides of the machine 100 to control the drill speed, thrust pressure and rotation pressure from the same location by using the remote regulator 138. Moreover, the remote regulator 138 is convenient, easy to manufacture and cost effective.

Further, using the main control valve 130, an upper limit of the thrust pressure and an upper limit of the rotation pressure may be preset. Further, using the remote regulator 138, the operator of the machine 100 may further regulate the thrust pressure to the drill thrust actuator 128 and the rotation pressure to the drill rotation actuator 124 within the preset upper limits of the thrust pressure and the rotation pressure.

In an aspect of the present disclosure, the first input device 304 may pushed inwards to selectively actuate the first pressure relief cartridge 406 for providing the drilling thrust to the drill thrust actuator 128 for drilling operation. The first input device 304 may be pulled outward to selectively actuate the second pressure relief cartridge 408 for providing rib drill thrust to the drill thrust actuator 128 for bolting operations.

Further, the second input device 306 may be pushed inwards to selectively actuate the third pressure relief cartridge 414 for providing the drilling torque to the drill rotation actuator 124 for drilling operations. Similarly, the second input device 306 may be pulled outwards to selectively actuate the fourth pressure relief cartridge 416 for providing bolting torque to the drill rotation actuator 124 for bolting operations.

Furthermore, the third input device 308 may be used by the operator to regulate the drill speed by rotating the knob either clockwise or counterclockwise. For example, the operator may turn the knob 308 in a clockwise direction to increase the drill speed and in a counterclockwise direction to decrease the drill speed, and vice-versa.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A regulator for controlling operation of a drill thrust actuator and a drill rotation actuator in a roof bolter, the regulator comprising:
a first pressure relief unit configured to selectively allow a hydraulic fluid to pass to the drill thrust actuator;
a second pressure relief unit configured to selectively allow the hydraulic fluid to pass to the drill rotation actuator; and
a flow control valve configured to selectively adjust a flow of the hydraulic fluid to the drill rotation actuator.

2. The regulator of claim 1, wherein the first pressure relief unit includes:
a first pressure relief cartridge valve configured to provide a first pressure relief for the drill thrust actuator; and
a second pressure relief cartridge valve configured to provide a second pressure relief for the drill thrust actuator.

3. The regulator of claim 2, wherein the regulator further including a first three-way valve configured to selectively actuate at least one of the first and the second pressure relief cartridge valves.

4. The regulator of claim 3 further including a first input device associated with the first three-way valve.

5. The regulator of claim 1, wherein the second pressure relief unit including:
a third pressure relief cartridge valve configured to provide a first pressure relief for the drill rotation actuator; and
a fourth pressure relief cartridge valve configured to provide a second pressure relief for the drill rotation actuator.

6. The regulator of claim 5, wherein the regulator further including a second three-way valve configured to selectively actuate at least one of the third and the fourth pressure relief cartridge valves.

7. The regulator of claim 6 further including a second input device associated with the second three-way valve.

8. The regulator of claim 1 further including a third input device associated with the flow control valve.

9. A roof bolter comprising:
a drill assembly having a drill thrust actuator and a drill rotation actuator;
a main control valve configured to supply a hydraulic fluid to the drill thrust actuator and the drill rotation actuator; and
a regulator hydraulically coupled to the main control valve, the regulator including:
a first pressure relief unit configured to selectively allow the hydraulic fluid to pass to the drill thrust actuator;
a second pressure relief unit configured to selectively allow the hydraulic fluid to pass to the drill rotation actuator; and
a flow control valve configured to selectively adjust a flow of the hydraulic fluid to the drill rotation actuator.

10. The roof bolter of claim 9, wherein the first pressure relief unit including:
a first pressure relief cartridge valve configured to provide a first pressure relief for the drill thrust actuator; and
a second pressure relief cartridge valve configured to provide a second pressure relief for the drill thrust actuator.

11. The roof bolter of claim 10, wherein the regulator further including a first three-way valve configured to selectively actuate at least one of the first and the second pressure relief cartridge valves.

12. The roof bolter of claim 9, wherein the second pressure relief unit including:
a third pressure relief cartridge valve configured to provide a first pressure relief for the drill rotation actuator; and
a fourth pressure relief cartridge valve configured to provide a second pressure relief for the drill rotation actuator.

13. The roof bolter of claim 12, wherein the regulator further including a second three-way valve configured to selectively actuate at least one of the third and the fourth pressure relief cartridge valves.

14. The roof bolter of claim 9, wherein the main control valve includes a main pressure relief unit configured to set an upper thrust pressure and an upper rotation pressure to the regulator.

15. A regulator for controlling operation of a drill thrust actuator and a drill rotation actuator of a roof bolter, the regulator comprising:
a first pressure relief cartridge valve configured to provide a first pressure relief for the drill thrust actuator;
a second pressure relief cartridge valve configured to provide a second pressure relief for the drill thrust actuator;
a third pressure relief cartridge valve configured to provide a first pressure relief for the drill rotation actuator;
a fourth pressure relief cartridge valve configured to provide a second pressure relief for the drill rotation actuator; and
a flow control valve configured to selectively adjust a flow of the hydraulic fluid to the drill rotation actuator.

16. The regulator of claim 15, wherein the regulator further including a first three-way valve configured to selectively actuate at least one of the first and the second relief valves.

17. The regulator of claim 15, wherein the regulator further including a second three-way valve configured to selectively actuate at least one of the third and the fourth relief valves.

18. The regulator of claim 15 further including a first input device associated with the first three-way valve.

19. The regulator of claim 15 further including a second input device associated with the second three-way valve.

20. The regulator of claim 15 further including a third input device associated with the flow control valve.
